(19) United States
(12) Patent Application Publication
(10) Pub. No.: US 2005/0235921 A1
(43) Pub. Date: Oct. 27, 2005

(54) Self-deployable open ocean aquaculture cages and underwater structures

(75) Inventors: Christopher Niezrecki, Merrimack, NH (US); Nam-Ho Kim, Gainesville, FL (US)

Correspondence Address: AKERMAN SENTERFITT, P.O. BOX 3188, WEST PALM BEACH, FL, 33402-3188, US

(73) Assignee: University of Florida Research Foundation, Inc., Gainesville, FL (US)

(21) Appl. No.: 11/111,449

(22) Filed: Apr. 21, 2005

Related U.S. Application Data
(60) Provisional application No. 60/565,168, filed on Apr. 23, 2004.

(51) Int. Cl. A01K 61/00

(52) U.S. Cl. 119/223

(57) ABSTRACT

A self-deployable open ocean aquaculture cage that includes at least one elongate flexible support member having an open interior for receiving a fluid and a net that forms an enclosure capable of retaining fish, wherein the at least one flexible support member is constructed and arranged to hold the net in a substantially extended configuration.

### CROSS-REFERENCE TO RELATED APPLICATIONS

This application claims priority to U.S. Provisional Patent Application No. 60/565,168, which was filed Apr. 23, 2004.

### STATEMENT REGARDING FEDERALLY SPONSORED RESEARCH OR DEVELOPMENT

The United States Government may have certain rights in this invention pursuant to U.S. Department of Commerce, Florida Sea Grant No. PD-01-5NA76RG0120.

### FIELD OF THE INVENTION

This invention relates to aquaculture devices and, in particular, to open ocean aquaculture cages and other underwater structures.

### BACKGROUND OF THE INVENTION

The increasing demands of the world population on ocean resources have resulted in severe over-fishing in many parts of the world. Without supplementation through aquaculture, worldwide fisheries production will be increasingly unable to meet the needs of the growing human population. In particular, open ocean aquaculture (OOA) is one area that shows great promise to meet the needs of world markets. Applied to U.S. waters, it is also believed that OOA has the potential to have a significant impact within the waters of Florida, the Atlantic coast, the Pacific coast, the Gulf of Mexico, and the Caribbean Sea.

Current OOA cage design generally may be classified into one of four general categories. Class 1 cages rely on buoyancy and gravitational forces to maintain their shape and are typically referred to as gravity cages. Class 2 cages are anchor tensioned while Class 3 cages are self-supporting cages that resist net deformation due to a combination of tension in the flexible members and compression in the rigid members. Class 4 cages are rigid self-supporting structures typically constructed from beams and jointed members. A variety of different types of cages are commercially available, such as from Bridgestone, Polar Cirkel, Farm Ocean, Sadco-Shelf, and Ocean Spar Technologies, L.L.C.

The central spar and cage rims of the class 3 cages are currently made of solid members. This allows the cages to be semi-rigid. The loading on these members is primarily compressive due to their design. As a result of the solid member design, the transportation and assembly of such cages is an arduous and expensive task. Transportation generally requires cranes, the appropriate harbor, and then the cage has to be towed out to sea. In addition to the assembly problems, large scale cages are very expensive.

### SUMMARY OF THE INVENTION

An open ocean aquaculture device of the present invention includes flexible support members that, when not in use, are capable of being collapsed and/or folded into a small volume. The flexible support members can be filled with a pressurized fluid and become substantially rigid and capable of withstanding high external forces. A net may then be connected to the support members.

In one aspect, the present invention provides a submersible aquaculture device, including at least one elongate flexible support member having an open interior for receiving a fluid and a net that forms an enclosure capable of retaining fish, wherein the at least one flexible support member is constructed and arranged to hold the net in a substantially extended configuration.

In another aspect, the present invention provides a method of installing an underwater structure, including the steps of submersing a structure including at least one elongate flexible support member having an open interior for receiving a fluid and a net that forms an enclosure capable of retaining fish, and filling the open interior with a fluid, wherein the at least one flexible support member becomes at least semi-rigid after the filling step.

### BRIEF DESCRIPTION OF THE DRAWINGS

A fuller understanding of the present invention and the features and benefits thereof will be accomplished upon review of the following detailed description together with the accompanying drawings, in which:

FIG. 1(a) is a perspective view of a flexible hose member pressurized and free standing. FIG. 1(b) is a perspective view of a flexible hose member deflated and flexible.

FIG. 2(a) is a perspective view of a fully deployed cage having structural members according to one embodiment of the present invention, while FIG. 2(b) shows the cage in FIG. 2(a) after collapse, according to this embodiment of the invention.

FIG. 3 is a top view of a portion of an aquaculture device according to the present invention and showing a plurality of support tubes and reinforcement structures.

FIG. 4 is a perspective view of an alternative embodiment of a fully deployed cage according to the present invention and having a conical shape.

FIG. 5 is a perspective view of an alternative embodiment of a fully deployed cage according to the present invention and having a plurality of flexible support members.

FIG. 6(a) is a side view of an example of an aquaculture device according to the present invention. FIG. 6(b) is a top view of an example of an aquaculture device according to the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

The aquaculture devices of the present invention utilize one or more flexible tubes that are capable of being collapsed, folded and/or easily transported to a selected location when not in use. The flexible tubes are also selected such that they are capable of being filled with a pressurized fluid to form a substantially rigid support member that is capable of withstanding external forces that may be applied to the tube when deployed. These external forces may include, but are not limited to, any water current under the water surface; forces exerted by waves contacting the device; forces exerted on the support member by riggings used to connect the nets to the device; or a combination thereof.

The flexible tubes may be composed of rubber, composite materials, vinyl, foam, cloth, or virtually any kind of fiber that may be woven into a tube shape. In addition, as pressurized fluid is used to inflate the tubes, in beneficial embodiments, the flexible tubes may be composed of substantially non-elastomeric materials. Nevertheless, elastomeric materials may also be used in the present invention. In an alternative embodiment, elastomeric materials having an inelastic element, such as nylon fibers or metal bands that are integrated with the elastomeric material, may also be used in the present invention. In one embodiment of the present invention, the flexible tube may be a polyvinyl chloride (PVC) discharge hose.

The flexible support tubes used in the present invention may be any size. Depending on the size of the selected device, the diameter of the tube may vary, with larger diameter tubes being used for larger aquaculture devices. In one embodiment, the tube has a diameter of from about 1 inch to about 40 inches. In an alternative embodiment, the tube has a diameter of from about 2 inches to about 16 inches. Again, it is to be understood that smaller or larger diameter tubes may be used depending on the selected use of the aquaculture device.

As discussed, the flexible support tubes used in the devices of the present invention are selected such that, when inflated, they are capable of withstanding external forces applied to the inflated tubes. For open ocean-located structures, the loading on the rigid supports members is essentially compressive. As a result, the tube support members are primarily designed to resist compressive loads associated with water currents; water pressure, and/or ropes or wires that connect the net to the support members. Once pressurized, the flexible members become able to supporting a large amount of force. This is due to the fact that force is the product of pressure and distributed area. For example, a tube member having a diameter of 3 ft. that is pressurized at 10 psi will have an internal tensile load of about 10,000 lbs, thereby enabling the tube member to withstand the compressive forces associated with water currents; water pressure, and/or ropes or wires that connect the net to the support members.

Accordingly, based upon the location of the device, the depth at which the device is deployed, the strength of any water currents, or a combination thereof, the flexible tube members, when inflated, may be in select embodiments, capable of supporting loads of about 40 psi or higher. In an alternative embodiment, the flexible tube members, when inflated, may be capable of supporting loads of about 80 psi or higher. In yet another alternative embodiment, the flexible tube members, when inflated, may be capable of supporting loads of about 100 psi or higher.

The flexible support tubes used in the present invention are able to support loads through the use of a pressurized fluid that is used to inflate the flexible support tubes. The pressurized fluid may be any fluid capable of being placed within a hollow tube including, but not limited to, air, water, or a combination thereof. As the devices of the present invention may be used in water environments, in select embodiments of the present invention, the pressurized fluid is water. Either fresh water or seawater may be used, as well as a combination of the two. In general, the water into which the device is deployed will be used to inflate the flexible support tubes. This may be accomplished, in one embodiment, through the use of a pump or related means for pumping water into the flexible support tubes. Water is beneficial as it is plentiful in the cage environment, easy to pump, and/or requires smaller volumes of water to achieve high pressures within the tubes as water is generally not compressible. In addition, many standard pumps can easily achieve pressures of 10 psi, 50 psi, or even 100 psi within the tubes when water is used as the pressurized fluid.

In an alternative embodiment, air or another gaseous fluid may be used to inflate the support members. In yet another alternative embodiment, a mixture of air and water may be used. In those embodiments wherein air or another gaseous fluid is used with water or a liquid, the air or other gaseous fluid may be used to help adjust the buoyancy of the device.

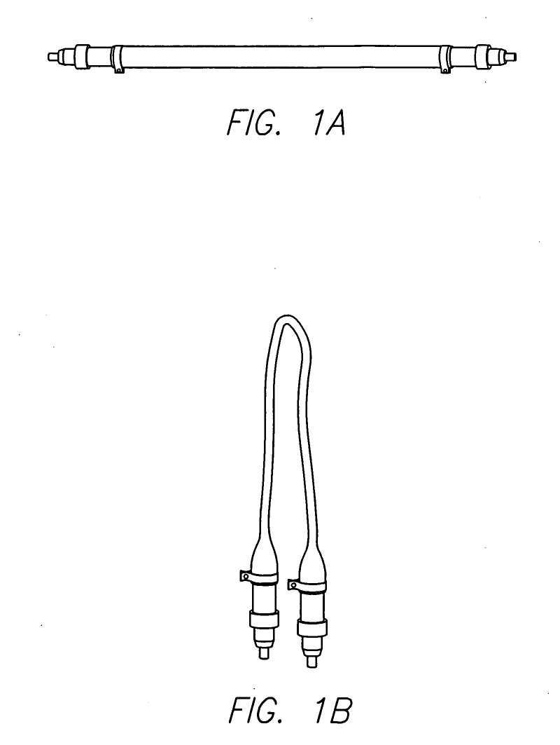

The stiffening effect has been demonstrated using prototype structural members and the results of the demonstration shown in FIGS. 1(a)-(b) for a flexible hose member 102 that is filled with water and thus pressurized and having ends 104 to help retain the pressurized fluid. FIG. 1(a) shows a flexible hose member 102 in a pressurized and free standing state, while FIG. 1(b) shows the hose member 102 in its deflated and flexible form after removal of the water. Thus, once the pressure has been removed, such as by removing the water inside, the flexible members retain their original flexibility and may be once again made very compact.

Additionally, while the tubes may be considered to have a circular cross-section, it is to be understood that the flexible tubes may have any geometric cross-section provided the tubes, when deflated, are capable of being collapsed and/or folded and, when inflated, are capable of withstanding external forces that may be exerted on the tube, such as from currents or connection of the nets to the inflated tubes.

In addition to the flexible support tubes or members, the aquaculture devices of the present invention include netting that is attached to the flexible support tubes. The netting may be connected in any conventional manner, such as the use of wire or rope or flexible ties. The netting is selected and/or connected to the flexible support tubes in a manner such that the netting, and the overall device, is capable of keeping and or cultivating fish or other aquatic life. As such, the netting is selected to have a mesh or opening size designed to keep fish or other aquatic life having a selected size within the aquaculture device. In addition, the netting is connected to the flexible support members in a manner that helps to prevent fish or other aquatic life from escaping from the aquaculture device.

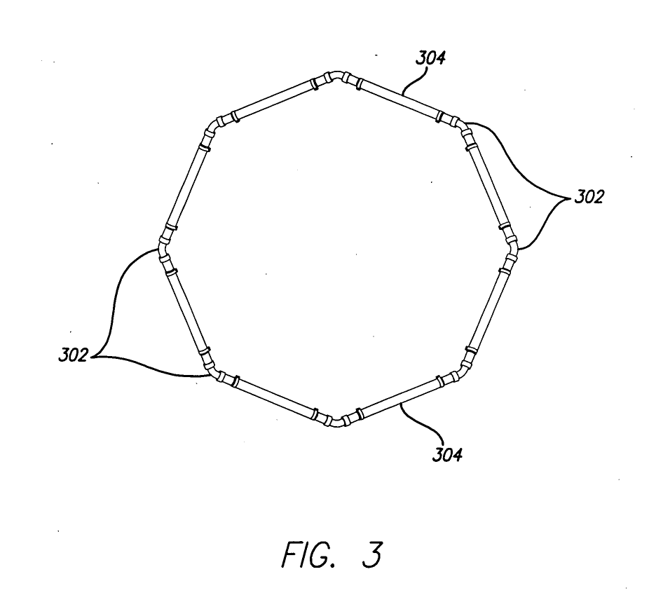

In certain embodiments, it may be beneficial to provide additional support to the aquaculture devices. Accordingly, in select embodiments, the aquaculture devices include an additional reinforcement structure. The reinforcement structure may be used to connect two or more flexible support members to one another to provide additional support to the device. For example, in one embodiment, which may be seen in FIG. 3, the reinforcement structure 302 may be PVC piping that is used to connect two flexible support members 304 to one another. This may be beneficial in those embodiments wherein the aquaculture device has a geometric shape, such as an octagonal periphery, that is formed using the flexible support members 304, and the reinforcement structure 302 may be used to form the corners of the octagon. While an octagon is shown, it is to be understood that the periphery of the device may be any geometric shape including, but not limited to, a triangle, a square, a pentagon, a hexagon, a heptagon, an octagon, a circle, or the like.

The flexible support tubes are used to provide the support for the aquaculture devices of the present invention. The resulting devices may then be used in any underwater environment, such as an ocean, sea, river or lake, or any other environment where fish may be kept and bred. The aquaculture device may be any shape or configuration capable of keeping and/or breeding fish or other underwater life.

These elements are flexible prior to underwater operation and the entire net/cage system may be rolled off the boat and deposited into the ocean or other body of water in its compact form. The flexible tube members may then be pressurized with a liquid and or gas, such as by using a pump. The fluid(s) filling the structural member will expand to deploy the device.

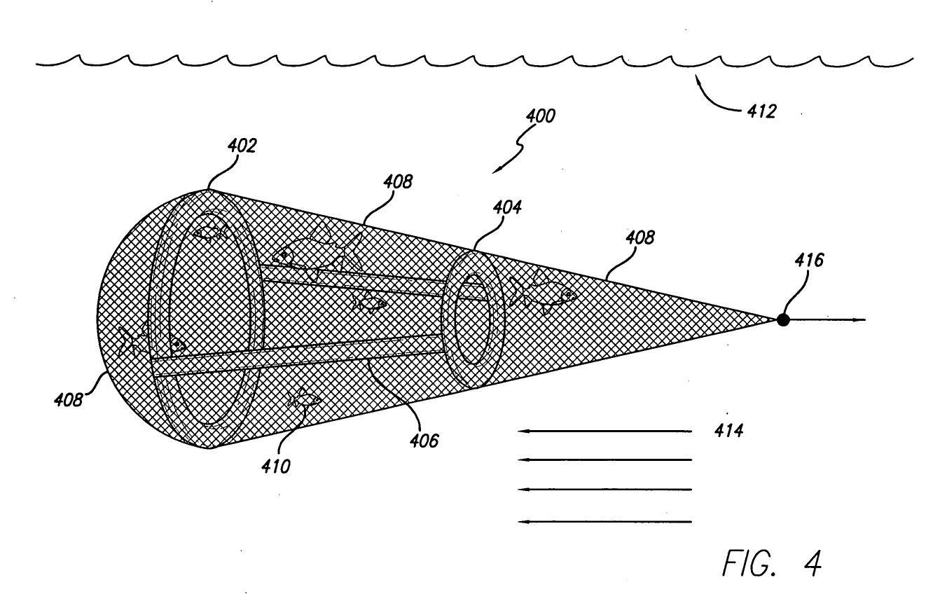

In an alternative embodiment, which may be seen in FIG. 4, the aquaculture device 400 of the present has a conical configuration. In this embodiment, a first pressurized ring 402 and a second pressurized ring 404, each made from a flexible support tube, are connected to one another using two pressurized straight members 406, which are also made from a flexible support tube. While two straight members 406 are shown, it is to be understood that any number of straight members may be used. The device 400 also includes a net 408 that is connected to the pressurized rings 402, 404 and the straight members 406. The net 408 helps to contain fish 410 within the device 400. The device 400 may be located under the water surface 412 and is designed to be beneficial at reducing drag associated with water current 414. The device 400 may be anchored using a connector 416.

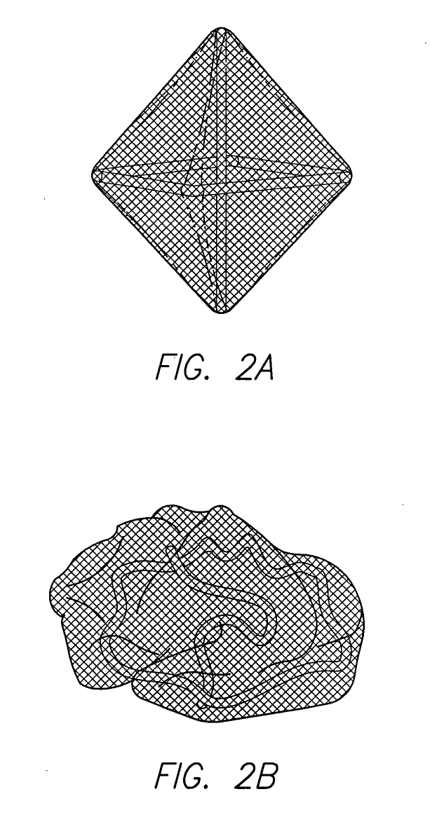

The flexible pressurized OOA device is a potentially enabling technology that may significantly improve open ocean aquaculture devices. It allows for devices that are less expensive and more easily manufactured than existing designs. The devices may be readily transported for the initial deployment and disassembled after harvesting. After harvesting, the device may be deflated and the entire net system may be lifted aboard a ship and redeployed at a later time or different location. FIG. 2(a) shows a fully deployed device 200 according to one embodiment of the invention while FIG. 2(b) shows the same device 200 after it has been collapsed.

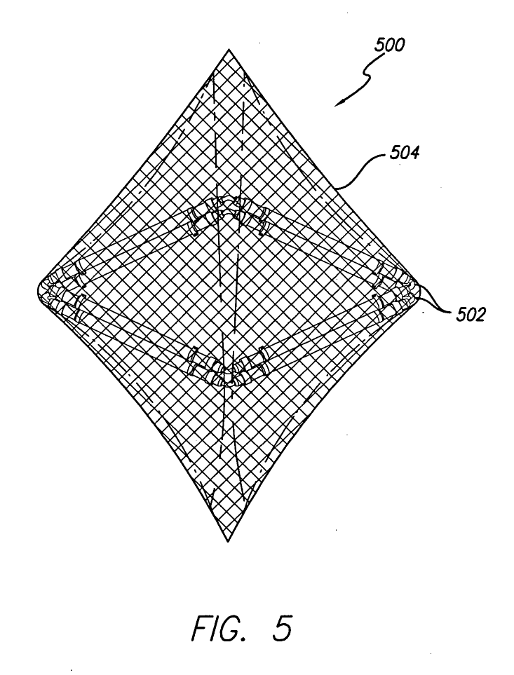

In an alternative embodiment of the present invention, the aquaculture devices may use a plurality of flexible support tubes to provide a failsafe mechanism for the device. In these embodiments, instead of a single flexible support tube being used to form a side of the aquaculture device, two or more tubes are used to form each side. As a result, if one of the flexible support tubes happens to fail, the device will not collapse as the device includes one or more additional flexible support tubes that may still operate to keep the aquaculture device employed. This embodiment may be seen in greater detail in FIG. 5, wherein the device 500 includes two flexible support tubes 502 for each side of a square-shaped device 500 as well as net 504.

The present invention utilizes pressurized flexible tubes that are capable of being collapsed and/or folded prior to deployment. As such, the device may be easily transported to a selected location and then placed in the selected location. Then, the device may be deployed by using a simple pump or any other means for injecting fluid into the flexible tubes such that the tubes fill with pressurized fluid to force the device to deploy and assume a selected shape.

Since the device is collapsible, the entire device may be transported on board a variety of boats rather than being towed into place after construction. The device is then placed at the selected location and deployed through the use of a pump. Because the device uses pressurized fluids, the device is sturdier than other collapsible systems that do not include any rigid structure and, therefore, easily collapse on themselves if the currents change. Potential collapse of the device may be disadvantageous since one of the more important factors in aquaculture cage design is maintaining a constant inner (divergence) volume. Maintaining the divergence volume helps to assure the health of the fish inside the cage.

The present invention is generally applicable to OOA devices and other underwater structures. Nevertheless, the present invention may have broad application for open ocean and/or sea uses. At present, OOA is in its infancy and commercial ventures are just beginning to take hold. Previous studies have shown that the economic feasibility of offshore aquaculture has become economically feasible. Leveraging the cost savings provided by the device design and method provided by the present invention, OOA is expected to become increasingly common. Although described herein for OOA, the invention is in no way limited to OOA. The invention may also be used for other underwater structural applications, such as various underwater structures that may be unrelated to aquaculture.

Reference will now be made to different embodiments and examples wherein the versatility of the present invention may be better understood. However, it is to be understood that these embodiments are for example purposes only and are not to be considered to be limiting in any manner of the overall scope of the present invention.

### EXAMPLES

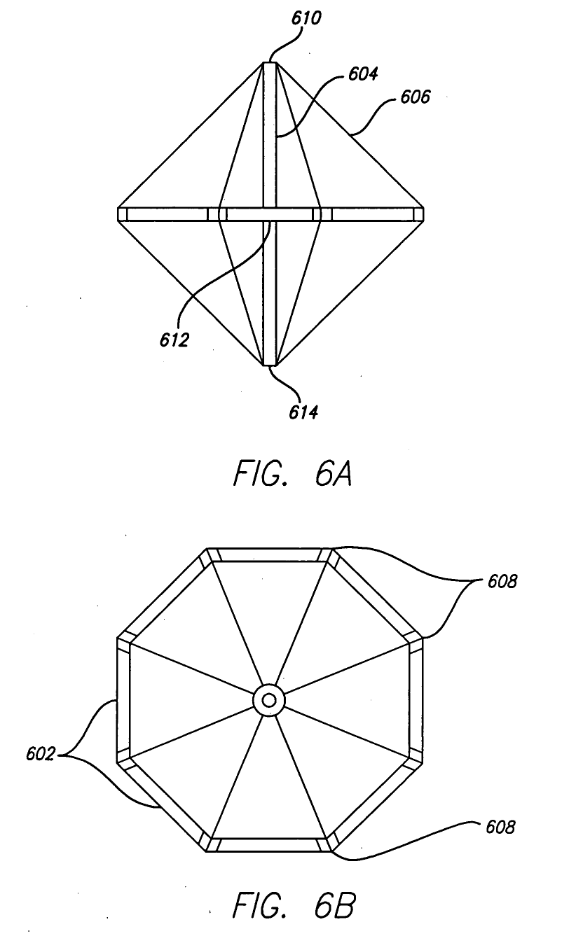

A device was constructed as described herein. The cage may be seen in FIGS. 6(a) and 6(b). The main structure included a 20 foot diameter octagon 602 and a 15 foot central beam 604. All beams were made out of 6 inch inflatable tubing. The shape was held by tension lines 606 connecting each corner 608 of the octagon 602 to the top 610, middle 612 and bottom 614 of the central beam 604. The lines 606 had carabineers (not shown) at each end which attached to eyehooks (not shown) screwed into the end-caps of the central spar 604 and onto metal rings (not shown) strapped to the eight corners 608 of the outer ring 602. The straps were made of climbing webbing and were glued in place such they did not slide back and forth over the fittings.

The central beam 604 was made of tubing with a PVC end cap at one end and a valve used for inflation at the other. The octagonal outer ring 602 was constructed as one continuous tube with 45 degree PVC elbows at each corner 606 and a valve (not shown) in the center of one side of the ring. Air elimination valves (not shown) were placed in two places on the ring and one place on the central spar in order to insure that only water was pressurized in the tubes. A gas powered water pump was used to inflate both the outer ring and the central beam individually. During inflation a pressure gage was inserted between the pump and the valve to accurately reach the working pressure of the tubing. This allowed for maximum rigidity. The working pressure for full rigidity for this cage was 40 psi.

During assembly the central beam was attached to an inflatable raft which kept it positioned vertically and then it was inflated using the pump. The deflated outer ring was then positioned around the central beam and partially attached to the top of the central beam using the upper tension lines. The ring was then inflated and the rest of the tension lines were attached and tightened. This concluded the main structure of the cage and its full strength came from constant inner pressure as well as taught tie lines.

Furthermore, a net covering was then placed around the cage structure. The netting included 8 diamond-shaped panels each assembled together using zip-ties. One of the seams had a large, heavy duty zipper glued to the netting. The zipper permitted the netting to fully open, easing the deployment of it. Initially the covering was attached to the top and bottom of the central spar using carabineers attached to the spar's eye hooks.

Although the illustrative embodiments of the present disclosure have been described herein with reference to the accompanying drawings and examples, it is to be understood that the disclosure is not limited to those precise embodiments, and various other changes and modifications may be affected therein by one skilled in the art without departing from the scope of spirit of the disclosure. All such changes and modifications are intended to be included within the scope of the disclosure as defined by the appended claims.

1. A submersible aquaculture device, comprising:
at least one elongate flexible support member having an open interior for receiving a fluid; and
a net that forms an enclosure capable of retaining fish;
wherein the at least one flexible support member is constructed and arranged to hold the net in a substantially extended configuration.

2. The device of claim 1, wherein the fluid is selected from water, air or a combination thereof.

3. The device of claim 1, wherein the at least one flexible support member is composed of a material selected from rubber, composite materials, vinyl, cloth, fibers, reinforced elastomeric materials or polyvinyl chloride discharge hose.

4. The device of claim 3, wherein the at least one flexible support member comprises a polyvinyl chloride discharge hose.

5. The device of claim 1, wherein the at least one flexible support member is capable of containing pressurized fluid having an internal pressure of greater than about 10 psi.

6. The device of claim 5, wherein the at least one flexible support member is capable of containing pressurized fluid having an internal pressure of greater than about 50 psi.

7. The device of claim 6, wherein the at least one flexible support member is capable of containing pressurized fluid having an internal pressure of greater than about 100 psi.

8. The device of claim 1, wherein the device is conical in shape.

9. The device of claim 1, wherein the at least one flexible support member forms a periphery in a shape selected from a triangle, a square, a pentagon, a hexagon, a heptagon, an octagon, or a circle.

10. The device of claim 1, wherein the device includes a plurality of flexible support members.

11. The device of claim 1, further comprising at least one reinforcement structure used to connect two flexible support members.

12. A method of installing an underwater structure, comprising the steps of:
submersing a structure including at least one elongate flexible support member having an open interior for receiving a fluid and a net that forms an enclosure capable of retaining fish; and
filling the open interior with a fluid, wherein the at least one flexible support member becomes at least semi-rigid after the filling step.

13. The method of claim 12, wherein the fluid is selected from water, air or a combination thereof.

14. The method of claim 12, wherein the at least one flexible support member is composed of a material selected from rubber, composite materials, vinyl, cloth, fibers, reinforced elastomeric materials or polyvinyl chloride discharge hose.

15. The method of claim 14, wherein the at least one flexible support member comprises a polyvinyl chloride discharge hose.

16. The method of claim 12, wherein a pump is used to fill the sealed volume with a fluid.

17. The method of claim 12, wherein the pump is used to regulate pressure within the at least one flexible support member.

18. The method of claim 12, wherein the pump is used to control a ratio of air to water within the at least one flexible support member.
